(19) United States
(12) Patent Application Publication
(10) Pub. No.: US 2009/0058889 A1
(43) Pub. Date: Mar. 5, 2009

(54) DISPLAY PANEL DRIVER

(75) Inventor: Yuji NISHIMURA, Miyazaki (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/175,480

(22) Filed: Jul. 18, 2008

(30) Foreign Application Priority Data
Sep. 4, 2007 (JP) 2007-228841

(51) Int. Cl. G09G 5/10

(52) U.S. Cl. 345/690

(57) ABSTRACT

A display panel driver including a selector circuit provided between a holding circuit and a converter circuit is disclosed. The display panel driver replaces a bit value of a higher order bit of display data with a lower order bit thereof according to a test signal input to the selector circuit.

### BACKGROUND OF THE INVENTION

1. Field of the Invention

The present invention relates to a display panel drive apparatus or driver which provides a display panel drive voltage based on a received image data signal.

2. Description of the Related Art

For a thin display device such as a TFT LCD panel, there has been a need to connect a plurality of LCD panel drive LSIs to a number of electrodes extending from the display panel reliably in a reduced space at low costs.

Recently, as thin display devices have increased in size, the number of drivers in one LSI has increased and a layout of data bus lines has been elongated in a horizontal direction. The horizontally elongated layout of data bus lines has a problem in that defects such as shorts easily occur in adjacent lines due to foreign substance introduced in manufacturing processes.

Japanese Patent Application Publication No. 4-97690 (Patent Document 1) has disclosed a method for detecting defects of data bus lines in which a specific image is displayed to specify the locations of such line defects.

In the method for detecting defects of data bus lines described in Patent Document 1, an image test is conducted by displaying a stripe pattern bent at a specific angle, thereby enabling detection of defects of data bus lines.

However, this method has the following problem when the relation between a set gray level and a grayscale voltage in the TFT LCD panel is represented by a graph characterized by a γ curve as shown in FIG. 1. When a short defect has occurred in a wire corresponding to a color image data signal of the least significant bit, the grayscale voltage undergoes little change so that it is difficult to display the defect part since a change in the set gray level in the X axis around the center of the the graph causes a very small change in the grayscale voltage in the Y axis.

### SUMMARY OF THE INVENTION

Therefore, the present invention has been made in view of the above problems, and it is an object of the present invention to provide a display panel driver that can easily detect defects of data bus lines even when the grayscale voltage undergoes a very small change with a change in the set gray level.

In accordance with the present invention, the above and other objects can be accomplished by the provision of a display panel driver including a plurality of data bus lines for providing an image data signal, a holding circuit for receiving and holding the image data signal on the data bus lines as display data of a plurality of bits, a converter circuit for converting the display data held by the holding circuit into a corresponding grayscale voltage, and a drive unit that generates a drive voltage corresponding to the grayscale voltage, wherein the display panel driver further includes a selector circuit that is provided upstream of the converter circuit to replace a bit value of a more significant bit or higher order bit of the plurality of bits of the display data with a less significant bit or lower order bit therein according to a test signal received through at least one test signal input terminal.

For example, the higher order bit may be a most significant bit and the lower order bit may be a least significant bit.

The selector circuit may include a plurality of test signal input terminals and may replace a bit value of a higher order bit of the plurality of bits of the display data with a lower order bit therein corresponding to a test signal received through one of the plurality of test signal input terminals.

In addition, for example, the image data signal may be a color image data signal.

The display panel driver according to the invention can easily detect defects of data bus lines since the selector circuit included in the display panel driver can replace the bit value of a higher order bit with the bit value of a lower order bit according to the test signal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph illustrating the relation between a set gray level and a grayscale voltage of a conventional display panel driver;

FIG. 2 is a block diagram of a display panel drive apparatus or driver according to a first embodiment of the invention;

FIG. 3 schematically illustrates transmissions of color image data signals in the display panel driver according to the first embodiment of the invention;

FIG. 4 is a block diagram of a driver circuit for an i-th source driver terminal that is surrounded by an alternate long and short dash line 3 in FIG. 2;

FIG. 5 illustrates a truth table that describes input and output results of a selector circuit in the display panel driver in the first embodiment of the invention;

FIG. 6 is an example graph illustrating the relation between a set gray level and a grayscale voltage when a test signal has been input in the display panel driver of the first embodiment of the invention;

FIG. 7 is a block diagram of a driver circuit for an i-th source driver terminal in a display panel driver according to a second embodiment of the invention; and

FIG. 8 illustrates relations between test signals input to and signals output from a selector circuit in the display panel driver according to the second embodiment of the invention.

### DETAILED DESCRIPTION OF THE PREFERRED EMBODIMENTS

Embodiments of the invention will now be described in detail with reference to the accompanying drawings.

### First Embodiment

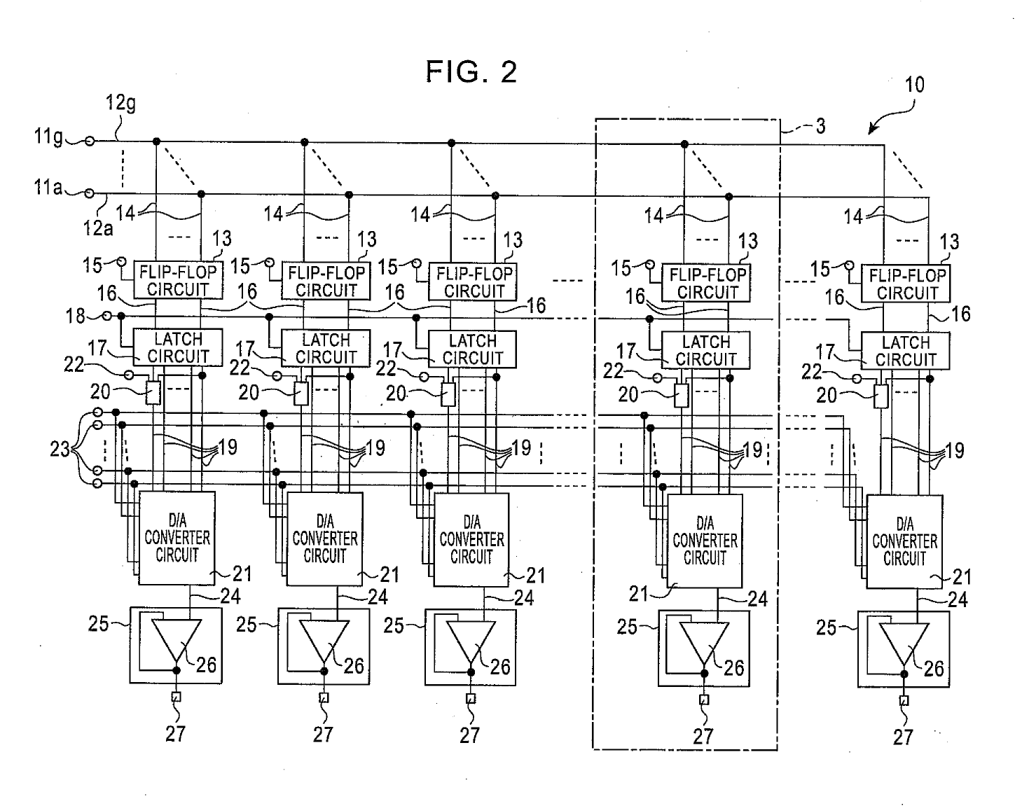

FIG. 2 is a block diagram of a display panel drive apparatus or driver 10 of 7-bit grayscale according to a first embodiment of the invention.

As shown in FIG. 2, seven data bus lines 12a to 12g are connected respectively to seven color image data input terminals 11a to 11g through which color image data signals are input. In FIG. 2, only two data bus lines 12a and 12g and only two input terminals 11a and 11g are illustrated while the remaining data bus lines and input terminals are represented simply by dashed lines. In the following description, the data bus lines 12a to 12g will be simply referred to as data bus lines 12 unless one is specified and the color image data input terminals 11a to 11g will be simply referred to as color image data input terminals 11 unless one is specified. Inputting a monochrome image data signal instead of the color image data signal is also effective in this embodiment when it is taken into consideration that the gray voltage is nonlinear with the monochrome gray level.

The seven data bus lines 12 are connected to each of a plurality (“x”) of flip-flop circuits 13 (x: arbitrary number) through seven independent wires 14, respectively. In FIG. 2, only two wires 14 are illustrated while the remaining wires are represented simply by dashed lines. A shift clock input terminal 15 is connected to each of the flip-flop circuits 13. Through the shift clock input terminal 15, a shift clock signal is input to the flip-flop circuit 13 to cause the flip-flop circuit 13 to transmit a color image data signal at a predetermined time. Although the number of the wires 14 connected to each of the flip-flop circuits is 7 since the number of grayscale bits set in the display panel driver 10 is 7 in this embodiment, the number of the wires 14 is not limited to 7 and may be designed differently depending on the number of grayscale bits.

A latch circuit 17 is connected to each of the flip-flop circuits 13 through seven wires 16. In FIG. 2, only two wires 16 are illustrated while the remaining wires are represented simply by dashed lines. The wires 16 connected between the flip-flop circuit 13 and the latch circuit 17 receive respective color image data signals of the grayscale bits, which were input through the color image data input terminals 11, via the flip-flop circuit 13, respectively. Therefore, as with the wires 14, the number of the wires 16 is equal to the number of grayscale bits (7 in this embodiment). Accordingly, as with the wires 14, the number of the wires 16 changes as the number of grayscale bits changes. The latch circuit 17 is also connected to a latch signal input terminal 18.

Each of the latch circuits 17 is connected to a D/A converter circuit 21 through wires 19 and a selector circuit 20. A test signal input terminal 22 is connected to each selector circuit 20. Through the test signal input terminal 22, a test signal is input to the selector circuit 20 to perform bit value replacement as described below. Details of wirings between the latch circuit 17, the selector circuit 20, and the D/A converter circuit 21 will be described below in detail. 128 grayscale voltage input terminals 23 are connected to each of the D/A converter circuits 21. In FIG. 2, only four grayscale voltage input terminals 23 are illustrated while the remaining grayscale voltage input terminals are represented simply by dashed lines. Although the number of the grayscale voltage input terminals 23 is 128 since the number of grayscale bits set in the display panel driver 10 is 7 in this embodiment, the number of the grayscale voltage input terminals 23 is not limited to 128 and may be designed differently depending on the number of grayscale bits.

Each of the D/A converter circuits 21 is connected to a voltage follower circuit 25 through a wire 24. Each of the voltage follower circuits 25 may include an operational amplifier 26. Each of the voltage follower circuits 2 is also connected to a source driver terminal 27.

The display panel driver 10 is constructed by combining a plurality of driver circuits, each including the individual components 13 to 27 described above.

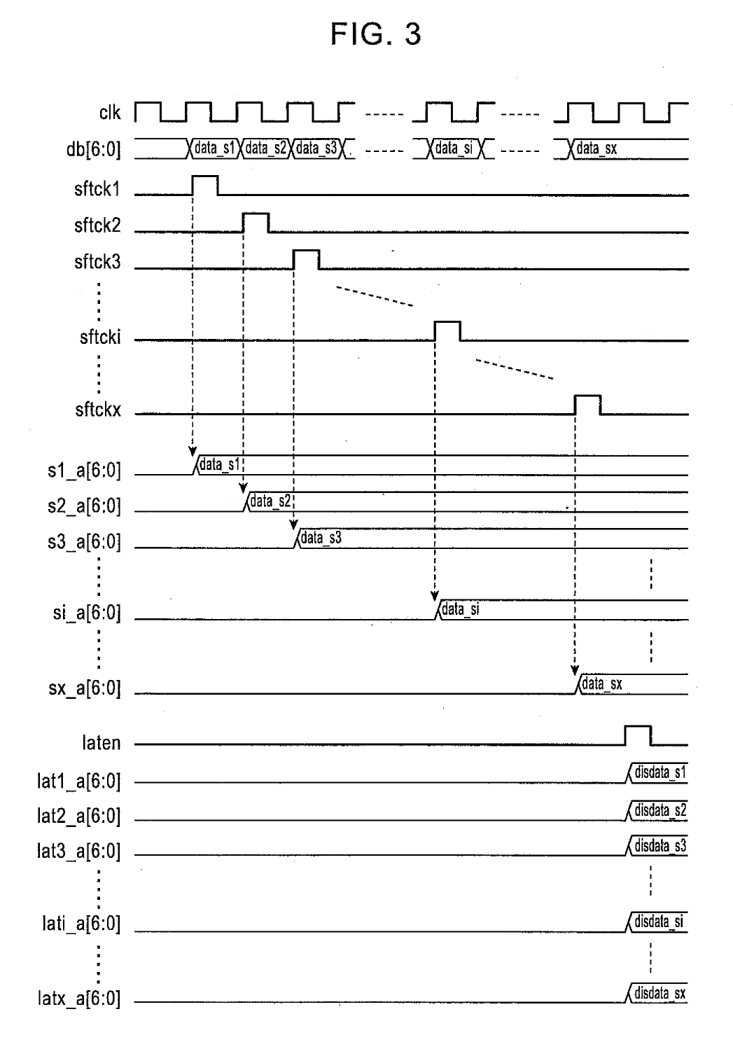

FIG. 3 schematically illustrates transmissions of color image data signals in a display panel driver according to the first embodiment of the invention. Signal names are written at the left side of FIG. 3. The overall flow of transmissions of color image data signals will now be described in detail with reference to FIG. 3. Transmission of each bit of color image data signals will be described later.

First, a clock signal clk having a predetermined period is generated as shown in a top portion of FIG. 3. For example, a clock signal may be generated by a piezoelectric device such as a quartz device. Then, a color image data signal db[6:0] is generated according to an input signal from each color image data input terminal 11. The color image data signal db[6:0] includes x pieces of color image data “data_s1” to “data_sx” where x is an integer greater than 1. The number of pieces of color image data (data_s1) to (data_sx) corresponds to or is equal to the number of the source driver terminals 27. The pieces of color image data “data_s1” to “data_sx” are transmitted to the corresponding flip-flop circuits 13, respectively. For example, a number expressed in hexadecimal may be set in the color image data “data_s1” to “data_sx”.

As shown in FIG. 3, the pieces of color image data “data_s1” to “data_sx” are transmitted sequentially, starting from “data_s1”, to the latch circuits 17 according to shift clock signals “sftck1” to “sftckx” (x: integer greater than 1) that are received at predetermined times through the shift clock input terminals 15. Transmissions of the pieces of color image data “data_s1” to “data_sx” are represented by dashed arrows in FIG. 3. F/F signals carrying the color image data “data_s1” to “data_sx” from the flip-flop circuits 13 to the latch circuits 17 are denoted by “s1_a[6:0]” to “sx_a[6:0]”, where x is an integer greater than 1. The term “F/F signals” is used to describe color image data signals transmitted from the flip-flop circuits 13 to distinguish them from the color image data signals received through the color image data input terminals 11. The shift clock signals are generated according to the clock signal clk having a predetermined period.

According to latch signals “laten” received through the latch signal input terminals 18, the latch circuits 17 hold the F/F signals “s1_a[6:0]” to “sx_a[6:0]” transmitted from the flip-flop circuits 13 as 7-bit display data “disdata_s1” to “disdata_sx”, respectively, and then transmit the 7-bit display data “disdata_s1” to “disdata_sx” to the D/A converter circuits 21, respectively. LAT signals carrying the 7-bit display data “disdata_s1” to “disdata_sx” from the latch circuits 17 to the D/A converter circuits 21 are denoted by “lat1_a[6:0]” to “latx_a[6:0]”, where x is an integer greater than 1. The D/A converter circuits 21 convert the LAT signals “lat1_a[6:0]” to “latx_a[6:0]” received from the latch circuits 17 into corresponding grayscale voltages. The voltage follow circuits 25 receive the grayscale voltages and output display panel drive voltages through the source driver terminals 27, respectively.

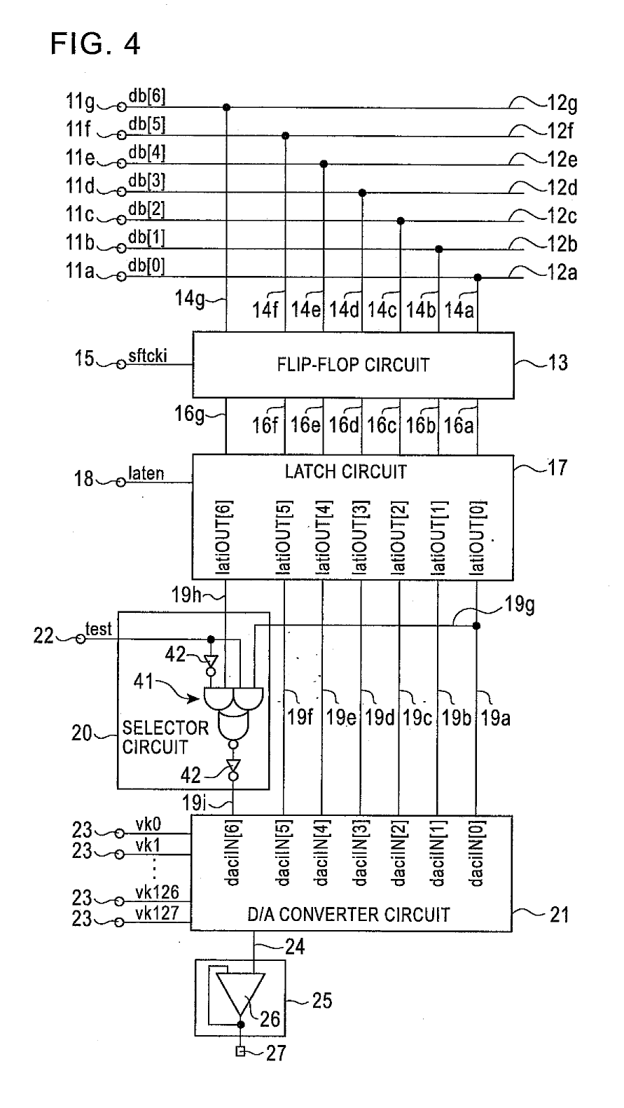

Data transmission of each bit of color image data signals will now be described in detail with reference to FIG. 4. FIG. 4 illustrates a driver circuit for the i-th source driver terminal 27, which is surrounded by an alternate long and short dash line 3 in FIG. 2.

7-bit color image data signals “db[0]” to “db[6]” generated according to input signals from the color image data input terminals 11 are input to the input terminals “F/FiIN[0]” to “F/FiIN[6]” (not shown) of the flip-flop circuit 13 through wires 14a to 14g, respectively. Here, “db[0]” denotes the least significant bit (LSB) and “db[6]” denotes the most significant bit (MSB). For example, the color image data signal db[0] is input to the input terminal F/FiIN[0] of the flip-flop circuit 13 through the wire 12a. Thereafter, at specific times according to a shift clock signal sftcki, F/F signals “si_a[0]” to “si_a[6]” are input from output terminals “F/FiOUT[0]” to “F/FiOUT[6]” (not shown) of the flip-flop circuit 13 to input terminals “latiIN[0]” to “latiIN[6]” (not shown) of the latch circuit 17 through wires 16a to 16g, respectively. For example, the F/F signal si_a[0] is input to the input terminal latiIN[0] of the latch circuit 17 through the wire 16a. Thus, the color image data signals “db[0]” to “db[6]” are input to the flip-flop circuit 13 and the latch circuit 17 through independent wires, respectively.

The latch circuit 17 receives and holds the F/F signals “si_a[0]” to “si_a[6]” as 7-bit display data “disdata_si[0]” to “disdata_si[6]” according to the latch signal “laten”. LAT signals “lati_a[0]” to “lati_a[5]” carrying respective bit values of the 7-bit display data “disdata_si[0]” to “disdata_si[5]” from the latch circuit 17 to the D/A converter circuits 21 are output through the output terminals “latiOUT[0]” to “latiOUT[5]” of the latch circuit 17 and are then input to the input terminals “daciIN[0]” to “daciIN[5] of the D/A converter circuit 21 through wires 19a to 19f. The LAT signal “lati_a[0]” carrying the bit value of the LSB (i.e., the bit value of the display data “disdata_si[0]”) is also input to the selector circuit 20 through a wire 19g. The LAT signal “lati_a[6]” carrying the bit value of the MSB (i.e., the bit value of the display data “disdata_si[6]”) is input from the output terminal “latiOUT[6]” of the latch circuit 17 to the selector circuit 20 through a wire 19h.

The selector circuit 20 receives the LAT signals “lati_a[0]” and “lati_a[6]” and outputs one of the LAT signals “lati_a[0]” and “lati_a[6]” to the input terminal “daciIN[6]” of the D/A converter circuit 21 through a wire 19i according to a test signal from the test signal input terminal 22.

The D/A converter circuit 21 receives one of grayscale voltage signals vk0 to vk127 through a grayscale voltage input terminal 23 based on the received bit values (i.e., bit values of the display data “disdata_si[0]” to “disdata_si[6]”) and generates a grayscale voltage corresponding to the received grayscale voltage signal. The generated grayscale voltage is input to the voltage follower circuit 25 through a wire 24. The voltage follower circuit 25 generates a display panel drive voltage based on the input grayscale voltage and outputs the drive voltage through the source driver terminal 27.

For example, the selector circuit 20 may include an AND-NOR hybrid gate 41 and an inverter 42 as shown in FIG. 4. A logic circuit, which constitutes the selector circuit 20 as shown in FIG. 4, obtains the negation of a negated logical sum of the logical product of input signals from the output terminal “latiOUT[0]” and the test signal input terminal 22 and the logical product of an input signal from the output terminal “latiOUT[6]” and the negation of the input signal from the test signal input terminal 22 and inputs a signal corresponding to the obtained value to the input terminal “daciIN[6]” of the D/A converter circuit 21.

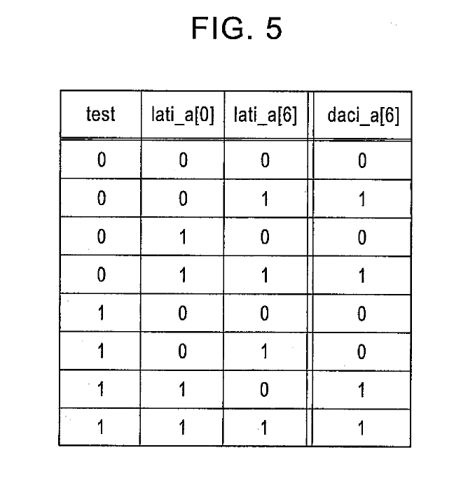

FIG. 5 illustrates a truth table that describes the operation of the selector circuit 20 including the logic circuit as described above. As shown in FIG. 5, the selector circuit 20 outputs the LAT signal “lati_a[6]” to the input terminal “daciIN[6]” of the D/A converter circuit 21 when the test signal is “0” (i.e., when no test signal is received) and outputs the LAT signal “lati_a[0]” to the input terminal “daciIN[6]” when the test signal is “1” (i.e., when the test signal is received). That is, when the test signal is input to the selector circuit 20, the bit value of the MSB (i.e., the bit value of the display data “disdata_si[6]”) is replaced with the bit value of the LSB (i.e., the bit value of the display data “disdata_si[0]”).

More specifically, when a hexadecimal value of “54” (“1010100” in binary) has been set through the color image data input terminals 11, the LAT signal “lati_a[0]” carries a bit value of “0” as display data, the LAT signal “lati_a[1]” carries a bit value of “0”, the LAT signal “lati_a[2]” carries a bit value of “1”, the LAT signal “lati_a[3]” carries a bit value of “0”, the LAT signal “lati_a[4]” carries a bit value of “1”, the LAT signal “lati_a[5]” carries a bit value of “0”, and the LAT signal “lati_a[6]” carries a bit value of “1”. When no test signal is input to the selector circuit 20, a binary value represented by LAT signals “lati_a[0]” to “lati_a[6]” output from the latch circuit 17 is equal to a binary value represented by LAT signals “lati_a[0]” to “lati_a[6]” input to the D/A converter circuit 21 (i.e., both the binary values are “1010100”). On the other hand, when the test signal is input to the selector circuit 20, the binary value represented by the LAT signals “lati_a[0]” to “lati_a[6]” input to the D/A converter circuit 21 is “0010100” such that both the binary values are different.

The selector circuit 20 is not limited to the configuration including the AND-NOR hybrid gate 41 and the inverter 42 as described above and may be constructed of an analog switch(es) (for example, a transfer circuit) provided that it constitutes a logic circuit which can select one of received signals according to a control signal.

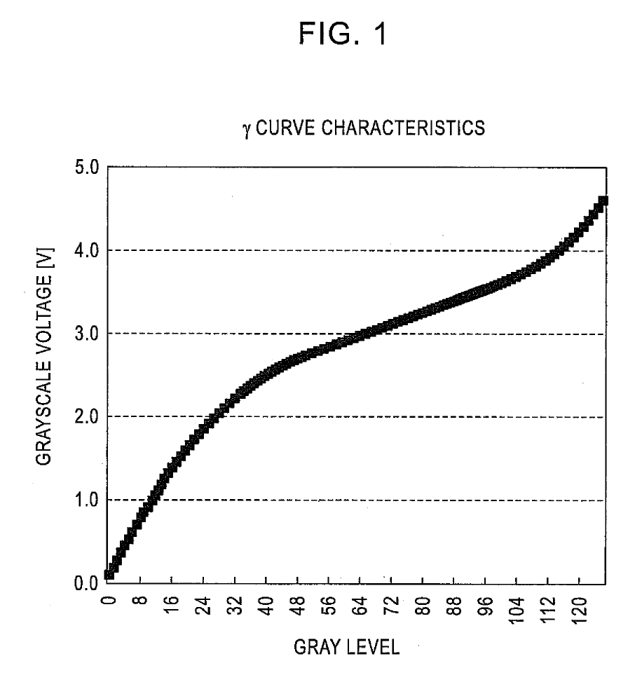

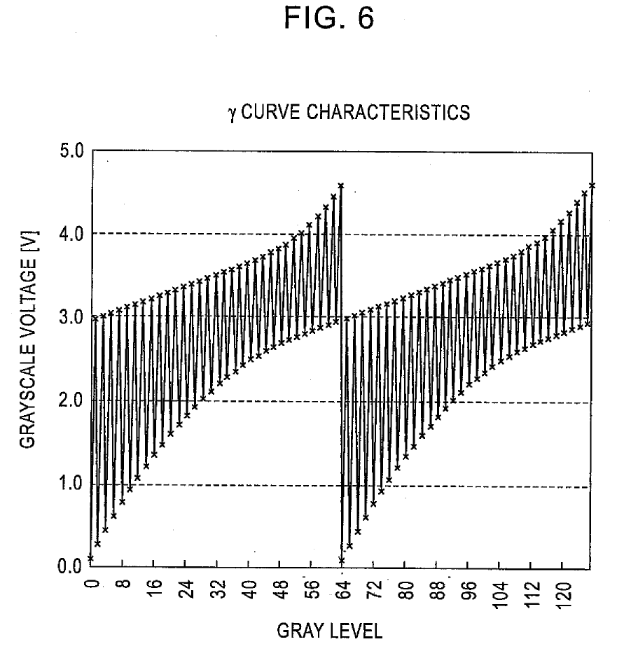

FIG. 6 is an example graph illustrating the relation between a set gray level and a grayscale voltage when a test signal has been input in the case where the selector circuit is provided in the display panel driver characterized by the γ curve shown in FIG. 1.

As can be seen from comparison of FIGS. 1 and 6, the graph of FIG. 6 exhibits a greater change in the grayscale voltage over adjacent gray levels than the graph of FIG. 1. As shown in the graph of FIG. 6, even though the set gray level is changed by only one at the center of the x axis (gray level), the grayscale voltage undergoes a sufficient change to detect short defects. Accordingly, even when the display panel driver has the relation between the set gray level and the grayscale voltage as shown in FIG. 1, the display panel driver can detect defects such as shorts of lower order bits by inputting a test signal to the selector circuit provided in the display panel driver.

Accordingly, when the data bus lines 12 are inspected for short defects, the test signal is output to replace the bit value of the MSB carried by the LAT signal lati_a[6] with the bit value of the LSB carried by the LAT signal lati_a[0], thereby increasing a change in the grayscale voltage as the bit value of the LAT signal lati_a[0] changes, thereby easily detecting short defects.

The output terminals of the latch circuit 17 connected to the selector circuit 20 are not limited to those of the LSB and MSB and may be selected according to setting of the display panel driver.

To determine whether or not short defects are present, grayscale voltages output from the source driver terminal 27 may be compared according to whether or not a test signal has been input and the compared result may be input to a display determinator (not shown) that determines, based on grayscale voltage differences, whether or not short defects are present.

The display panel driver according to this embodiment can easily detect defects such as shorts of data bus lines since the selector circuit can replace the bit value of a higher order bit input to the selector circuit with the bit value of a lower order bit as described above.

### Second Embodiment

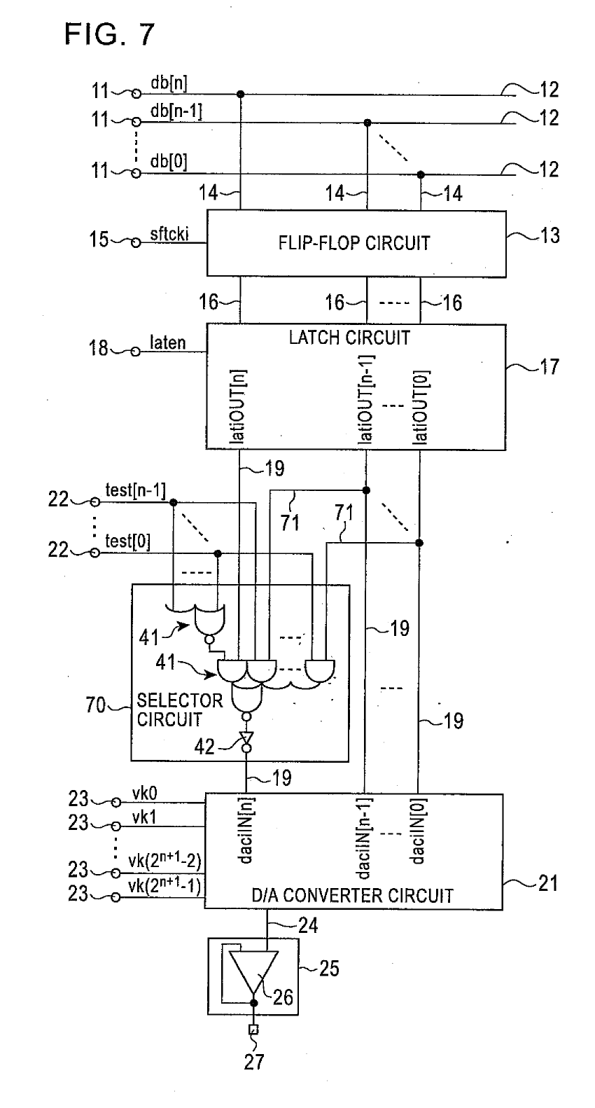

In this embodiment, a display panel driver of n+1-bit grayscale (n: integer greater than 0) includes a selector circuit that can replace the bit value of any higher order bit with the bit value of any lower order bit using test signals “[0]” to “[n−1]”. This display panel driver will now be described in detail with reference to FIG. 7. Components similar or equivalent to those of the first embodiment are denoted by the same reference numerals and a description of the equivalent components is omitted herein.

n-bit color image data signals “db[0]” to “db[n−1]” generated according to input signals from color image data input terminals 11, where “db[0]” corresponds to the LSB and “db[n−1]” corresponds to the MSB, are input to input terminals “latiIN[0]” to “latiIN[n−1]” (not shown) of a latch circuit 17 through wires 14, a flip-flop circuit 13, and wires 16. Similar to the first embodiment, the color image data signals “db[0]” to “db[n−1]” are transmitted to the flip-flop circuit 13 and the latch circuit 17 through independent wires, respectively.

The latch circuit 17 holds n+1-bit display data “disdata_si[0]” to “disdata_si[n]” according to the latch signal “laten”. LAT signals “lati_a[0]” to “lati_a[n−1]” carrying respective bit values of the n+1-bit display data from the latch circuits 17 to the D/A converter circuits 21 are output through the output terminals “latiOUT[0]” to “latiOUT[n−1]” of the latch circuit 17 and are then input to the input terminals “daciIN[0]” to “daciIN[n−1] of the D/A converter circuit 21 through wires 19. The LAT signals “lati_a[0]” to “lati_a[n−1]” are also input to a selector circuit 70 through wires 71. The LAT signal “lati_a[n]” carrying the bit value of the n+1th bit is input from the output terminal “latiOUT[n]” of the latch circuit 17 to the selector circuit 70 through a wire 19.

n test signal input terminals 22 are connected to the selector circuit 70 and test signals “[0]” to “[n−1]” are input to the selector circuit 70 through the test signal input terminals 22, respectively.

The selector circuit 70 receives the LAT signals “lati_a[0]” and “lati_a[n]” and outputs one of the LAT signals “lati_a[0]” to “lati_a[n]” to the input terminal “daciIN[n]” of the D/A converter circuit 21 through a wire 19 according to the test signals “[0]” to “[n−1]” received through the test signal input terminals 22.

The D/A converter circuit 21 receives one of grayscale voltage signals vk0 to vk2ⁿ⁺¹−1 through a grayscale voltage input terminal 23 based on the respective received bit values (i.e., bit values of the display data “disdata_si[0]” to “disdata_si[n]”) and generates a grayscale voltage corresponding to the received grayscale voltage signals. The generated grayscale voltage is input to the voltage follower circuit 25 through a wire 24. The voltage follower circuit 25 generates a display panel drive voltage based on the input grayscale voltage and outputs the drive voltage through the source driver terminal 27.

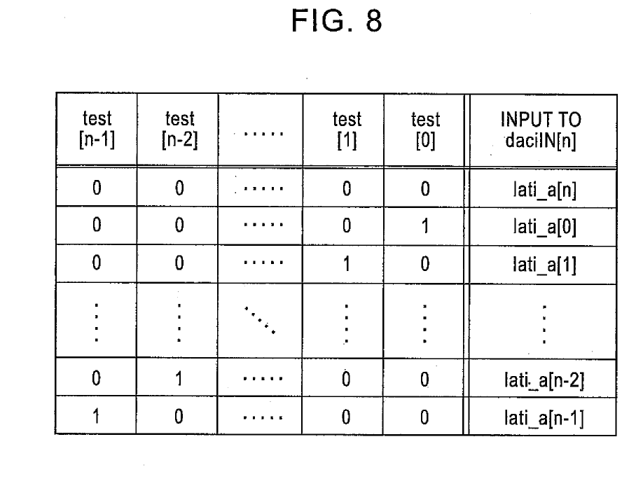

For example, the selector circuit 70 may include an AND-NOR hybrid gate 41, an inverter 42, and a NOR gate 43 as shown in FIG. 7 and may also include a logic circuit as shown in FIG. 7. Through this logic circuit, the selector circuit 70 calculates the logical product of the LAT signal lati_a[n] and a negated logical sum of the test signals “[0]” to “[n−1]”. The selector circuit 70 also calculates the respective logical products of the LAT signals lati_a[0] to [n−1] and the corresponding test signals “[0]” to “[n−1]”. The selector circuit 70 also calculates the negation of the logical sum of the logical products of the LAT signals and the test signals and outputs the negation of the logical sum. As a result, the logical circuit of the selector circuit 70 shown in FIG. 7 allows an LAT signal according to the test signal signals [n] to [n−1] to be input to the input terminal “daciIN[n]” of the D/A converter circuit 21. FIG. 8 illustrates relations between the test signals and the signals input to the input terminal “daciIN[n]”.

As shown in FIG. 8, the selector circuit 70 outputs an LAT signal of a bit corresponding to a test signal of “1” (i.e., a test signal that has been input to the selector circuit 70) to the input terminal “daciIN[n]” of the D/A converter circuit 21.

The selector circuit 70 is not limited to the structure including the AND-NOR hybrid gate 41, the inverter 42, and the NOR gate 43 as described above and may be constructed of an analog switch(es) (for example, a transfer circuit) provided that it constitutes a logic circuit which can select one of received signals according to a control signal.

The display panel driver according to this embodiment can easily detect defects such as shorts of data bus lines since the selector circuit can replace the bit value of a higher order bit input to the selector circuit with the bit value of a lower order bit according to a plurality of test signals input to the selector circuit through a plurality of test signal input terminals as described above.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Application No. 2007-228841 which is hereby incorporated by reference.

What is claimed is:

1. A display panel driver comprising:
a plurality of data bus lines for providing an image data signal;
a holding circuit for receiving and holding the image data signal on the data bus lines as display data of a plurality of bits;
a converter circuit for converting the display data held by the holding circuit into a corresponding grayscale voltage; and
a drive unit that generates a drive voltage corresponding to the grayscale voltage,
wherein the display panel driver further comprises a selector circuit that is provided upstream of the converter circuit to replace a bit value of a higher order bit of the plurality of bits of the display data with a lower order bit therein according to a test signal received through at least one test signal input terminal.

2. The display panel driver according to claim 1, wherein the higher order bit is a most significant bit.

3. The display panel driver according to claim 1, wherein the lower order bit is a least significant bit.

4. The display panel driver according to claim 1, wherein the selector circuit includes a plurality of test signal input terminals and replaces a bit value of a higher order bit of the plurality of bits of the display data with a lower order bit therein corresponding to a test signal received through one of the plurality of test signal input terminals.

5. The display panel driver according to claim 1, wherein the image data signal is a color image data signal.

6. A display panel driver comprising:
a latch circuit which latches each bit of display data, the display data comprising a plurality of bits and being provided through a plurality of data bus lines;
a selector circuit which receives a test signal to replace a bit value of a higher order bit of the plurality of bits of a latched display data by a lower order bit thereof according to a received test signal for provision to the converter; and
a converter which converts a replaced display data to generate a corresponding grayscale voltage.

7. The display panel driver according to claim 6, wherein the selector circuit receives a test designation signal which designates a higher order bit and a lower order bit of the plurality of bits of the display data to replace the bit value of the higher order bit by the bit value of the lower order bit.

8. The display panel driver according to claim 7, wherein the higher order bit is a most significant bit.

9. The display panel driver according to claim 7, wherein the lower order bit is a least significant bit.
